(19) United States
(12) Patent Application Publication
(10) Pub. No.: US 2026/0118715 A1
(43) Pub. Date: Apr. 30, 2026

(54) DISPLAY DEVICE

(71) Applicant: LG Display Co., Ltd., Seoul (KR)

(72) Inventor: SungSik Son, Daegu (KR)

(73) Assignee: LG Display Co., Ltd., Seoul (KR)

(21) Appl. No.: 19/093,188

(22) Filed: Mar. 27, 2025

(30) Foreign Application Priority Data
Oct. 28, 2024 (KR) 10-2024-0148793

(51) Int. Cl. G02F 1/13357

(52) U.S. Cl. CPC G02F 1/133606; G02F 1/133603; G02F 2202/28

(57) ABSTRACT

A display device may include a display panel, a decoration film disposed on the display panel, an adhesive layer which is disposed on the decoration film and is formed of thermoplastic polyurethane, and a cover window on the adhesive layer. Accordingly, the generation of bubbles of the display device is suppressed while applying a decoration film which is capable of forming various shapes and textures.

### CROSS-REFERENCE TO RELATED APPLICATIONS

This application claims the priority of Korean Patent Application No. 10-2024-0148793 filed on Oct. 28, 2024, in the Korean Intellectual Property Office, the disclosure of which is incorporated herein by reference.

### BACKGROUND

### Technical Field

The present disclosure relates to a display device, and more particularly, to a display device which applies a decoration film which is capable of forming various shapes and textures.

### Discussion of the Related Art

As it enters the information era, a field of a display device which visually expresses electrical information signals has been rapidly developed and studies are continued to improve performances of various display devices, such as a thin-thickness, a light weight, and low power consumption.

A representative display device may include a liquid crystal display device (LCD), a field emission display device (FED), an electro-wetting display device (EWD), and an organic light emitting display device (OLED).

An electroluminescent display device which is represented by an organic light emitting display device is a self-emitting display device so that a separate light source is not necessary, which is different from a liquid crystal display device. Therefore, the electroluminescent display device may be manufactured to have a light weight and a small thickness. Further, since the electroluminescent display device is advantageous not only in terms of power consumption due to the low voltage driving, but also in terms of color implementation, a response speed, a viewing angle, and a contrast ratio (CR), it is expected to be utilized in various fields.

### SUMMARY

Accordingly, embodiments of the present disclosure are directed to a display device that substantially obviates one or more of the problems due to limitations and disadvantages of the related art.

An aspect of the present disclosure is to provide a display device which applies a decoration film which is capable of forming various shapes and textures.

Another aspect of the present disclosure is to provide a display device which suppresses bubbles from being generated.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, a display device comprises a display panel, a decoration film disposed on the display panel, an adhesive layer which is disposed on the decoration film and is formed of thermoplastic polyurethane, and a cover window on the adhesive layer.

In another aspect, a display device comprises: a display panel including an active area in which the plurality of sub pixels is disposed and a non-active area which encloses the active area; a plurality of light emitting diodes which is disposed in each of the plurality of sub pixels; a decoration film disposed on the display panel, an adhesive layer which is disposed on the decoration film and is formed of thermoplastic polyurethane, and a cover window on the adhesive layer. In an emission mode of the plurality of light emitting diodes, an image input to the display panel is exposed and in a non-emission mode of the plurality of light emitting diodes, the decoration film is exposed.

Other detailed matters of the exemplary embodiments are included in the detailed description and the drawings.

According to the present disclosure, a decoration film is attached onto a cover window using an adhesive layer formed of thermoplastic polyurethane (TPU) to easily attach the decoration film with various shapes and textures to the cover window.

According to the present disclosure, even though a plurality of uneven structures is included on a surface of the cover window, the adhesive layer is fully filled between the plurality of uneven structures to suppress the generation of bubbles, thereby reducing a defect rate of the display device.

According to the present disclosure, even though a plurality of grooves is included on a surface of the decoration film, the adhesive layer is fully filled in the plurality of grooves to suppress the generation of bubbles, thereby reducing a defect rate of the display device.

It is to be understood that both the foregoing general description and the following detailed description are exemplary and explanatory and are intended to provide further explanation of the inventive concepts as claimed.

### BRIEF DESCRIPTION OF DRAWINGS

The accompanying drawings, which are included to provide a further understanding of the disclosure and are incorporated in and constitute a part of this application, illustrate embodiments of the disclosure and together with the description serve to explain various principles. In the drawings:

FIG. 1 is a schematic diagram of a display device according to an exemplary embodiment of the present disclosure;

FIG. 2 is a cross-sectional view of a display device according to an exemplary embodiment of the present disclosure;

FIG. 3A is an image illustrating a display device in a non-emission mode of a light emitting diode;

FIG. 3B is an image illustrating a display device in an emission mode of a light emitting diode;

FIGS. 4A to 4C are schematic diagrams illustrating a manufacturing method of a display device according to an exemplary embodiment of the present disclosure; and

FIG. 5 is a cross-sectional view of a display device according to another exemplary embodiment of the present disclosure.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, various exemplary embodiments of the present disclosure will be described in detail with reference to the accompanying drawings.

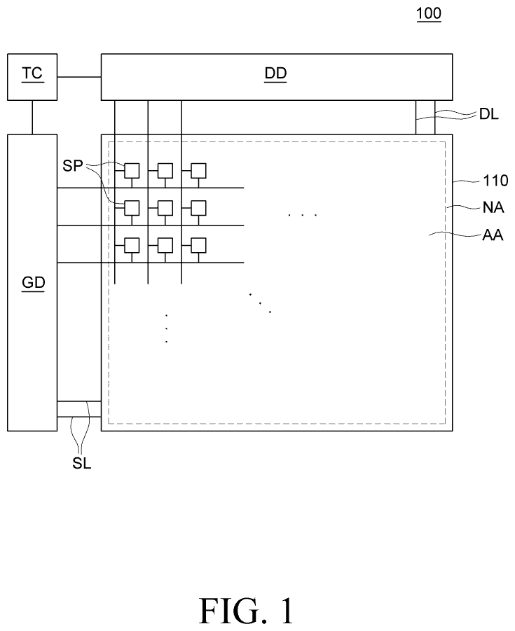

FIG. 1 is a schematic diagram of a display device according to an exemplary embodiment of the present disclosure. In FIG. 1, for the convenience of description, among various components of the display device 100, only a display panel 110, a gate driver GD, a data driver DD, and a timing controller TC are illustrated.

Referring to FIG. 1, the display device 100 includes a display panel 110 including a plurality of sub pixels SP, a gate driver GD and a data driver DD which supply various signals to the display panel 110, and a timing controller TC which controls the gate driver GD and the data driver DD.

The gate driver GD supplies a plurality of scan signals to a plurality of scan lines SL according to a plurality of gate control signals supplied from the timing controller TC. Even though in FIG. 1, it is illustrated that one gate driver GD is disposed to be spaced apart from one side of the display panel 110, the number of the gate drivers GD and the placement thereof are not limited thereto.

The data driver DD supplies a data voltage to a plurality of data lines DL according to a plurality of data control signals and image data supplied from the timing controller TC. The data driver DD converts the image data into a data voltage using a reference gamma voltage and supplies the converted data voltage to the plurality of data lines DL.

The timing controller TC aligns image data input from the outside to supply the image data to the data driver DD. The timing controller TC may generate a gate control signal and a data control signal using synchronization signals input from the outside, such as a dot clock signal, a data enable signal, and horizontal/vertical synchronization signals. The timing controller TC supplies the generated gate control signal and data control signal to the gate driver GD and the data driver DD, respectively, to control the gate driver GD and the data driver DD.

The display panel 110 is a configuration which displays images to the user and includes the plurality of sub pixels SP. In the display panel 110, the plurality of scan lines SL and the plurality of data lines DL intersect each other and the plurality of sub pixels SP is formed at intersections of the scan lines SL and the data lines DL.

In the display panel 110, an active area AA and a non-active area NA are defined.

The active area AA is an area in which images are displayed in the display device 100. In the active area AA, a plurality of sub pixels SP which configures a plurality of pixels PX and a pixel circuit for driving the plurality of sub pixels SP may be disposed. The plurality of sub pixels SP is a minimum unit which configures the active area AA and n sub pixels SP form one pixel PX. In each of the plurality of sub pixels SP, a thin film transistor for driving the plurality of light emitting diodes 120 may be disposed. The plurality of light emitting diodes 120 may be defined in different ways depending on the type of the display panel 110. For example, when the display panel 110 is an organic light emitting display panel, the light emitting diode 120 may be an organic light emitting diode.

In the active area AA, a plurality of signal lines which transmits various signals to the plurality of sub pixels SP is disposed. For example, the plurality of signal lines includes a plurality of data lines DL which supplies a data voltage to each of the plurality of sub pixels SP and a plurality of scan lines SL which supplies a scan signal to each of the plurality of sub pixels SP. The plurality of scan lines SL extends to one direction in the active area AA to be connected to the plurality of sub pixels SP and the plurality of data lines DL extends to a direction different from the one direction in the active area AA to be connected to the plurality of sub pixels SP. In addition, in the active area AA, a low potential power line and a high potential power line may be further disposed, but are not limited thereto.

The non-active area NA is an area where images are not displayed so that the non-active area NA may be defined as an area extending from the active area AA. In the non-active area NA, a link line which transmits a signal to the sub pixel SP of the active area AA, a pad electrode, or a driving IC, such as a gate driver IC or a data driver IC, may be disposed.

In the meantime, a driver, such as a gate driver GD, a data driver DD, and a timing controller TC, may be connected to the display panel 110 in various ways. For example, the gate driver GD may be mounted in the non-active area NA in a gate in panel (GIP) manner or mounted between the plurality of sub pixels SP in the active area AA in a gate in active area (GIA) manner.

For example, the data driver DD and the timing controller TC are formed in separate flexible film and printed circuit board. The display panel 110 is electrically connected to the data driver DD and the timing controller TC by bonding the flexible film and the printed circuit board to the pad electrode formed in the non-active area NA of the display panel 110.

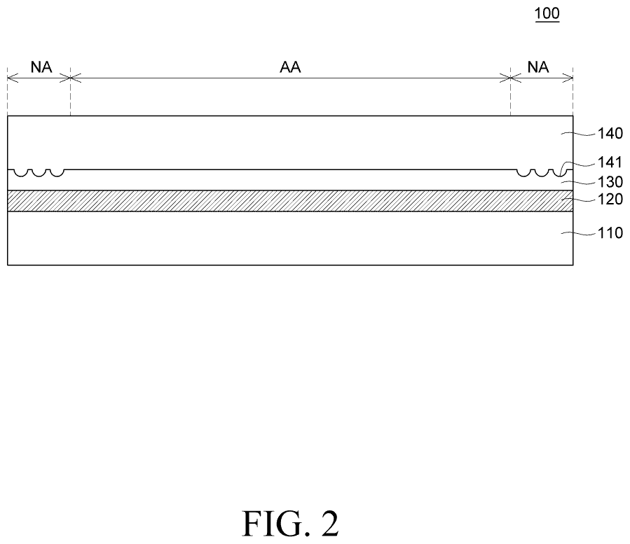

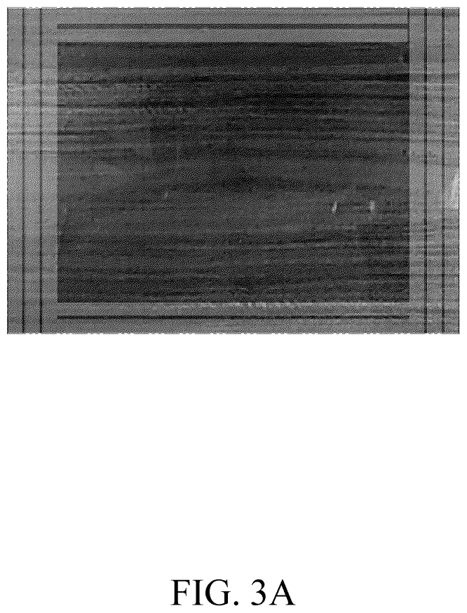

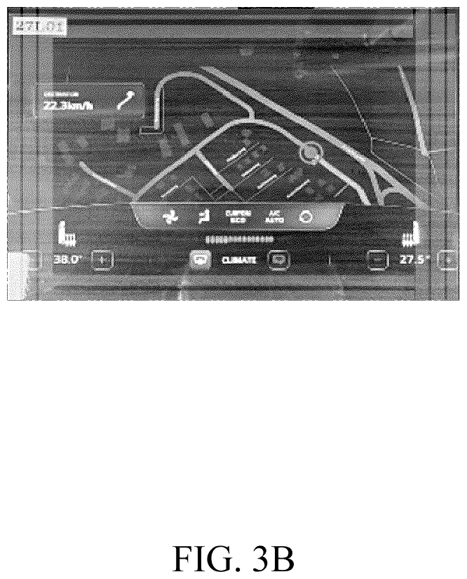

FIG. 2 is a cross-sectional view of a display device according to an exemplary embodiment of the present disclosure. FIG. 3A is an image illustrating a display device in a non-emission mode of a light emitting diode. FIG. 3B is an image illustrating a display device in an emission mode of a light emitting diode. In FIG. 2, for the convenience of description, among various configurations of the display device 100, only the display panel 110, a decoration film 120, an adhesive layer 130, and a cover window 140 are illustrated.

First, the display panel 110 may include a substrate, a thin film transistor, and a light emitting diode. In the display panel 110, the substrate on which the thin film transistor and the light emitting diode are formed is encapsulated by an encapsulation unit.

The substrate is a support member which supports various elements which configure the display panel 110 and is formed of an insulating material. For example, the substrate may be formed of glass or resin. For example, the substrate includes an insulating plastic selected from polyimide, polyethersulfone, polyethylene terephthalate, and polycarbonate or includes a polymer material, but is not limited thereto. For example, the substrate may be formed of a material having flexibility.

A driving transistor for driving a light emitting diode may be disposed on the substrate. The driving transistor may be disposed in each of the plurality of sub pixels SP. For example, the driving transistor includes a gate electrode, an active layer, a source electrode, and a drain electrode. The driving transistor may further include a gate insulating layer which insulates the gate electrode from the active layer and an interlayer insulating layer which insulates the gate electrode from the source electrode and the drain electrode.

The light emitting diode may be disposed on the substrate on which the driving transistor is disposed. For example, when the display panel 110 is an organic light emitting display panel, the light emitting diode may be an organic light emitting diode which includes an anode, an emission layer, and a cathode. For example, when the display panel 110 is a liquid crystal display panel, the light emitting diode may be a liquid crystal display element.

A decoration film 120 may be disposed on the display panel 110. The decoration film 120 forms an outer appearance of the display device 100. For example, the decoration film 120 may be used without limitation as long as it includes a pattern or a design, and for example, may be a film including a wood pattern or a stripe pattern, and the design or pattern of the decoration film 120 may be designed in various ways in consideration of the design.

The decoration film 120 may include a material which is less deformed by heat. The decoration film 120 may include a material having a high melting point, and for example, the melting point of the decoration film 120 may be 180° C. to 200° C.

The adhesive layer 130 is disposed on the decoration film 120. The adhesive layer 130 is formed of thermoplastic polyurethane. For example, the thermoplastic polyurethane is an eco-friendly plastic having elasticity similar to a rubber and when heat is applied to the thermoplastic polyurethane, the thermoplastic polyurethane is changed to be soft, that is, softened to be implemented in various shapes. Accordingly, the adhesive layer 130 may have excellent wear resistance, heat resistance, oil resistance, and low-temperature flexibility.

The adhesive layer 130 formed of thermoplastic polyurethane needs to be softened by the heat, but should not undergo performance deformation that it is completely melted by heat. To this end, the adhesive layer 130 in the display device 100 according to the exemplary embodiment of the present disclosure has a low modulus enough to be softened by the heat, but has a high melting point at which the adhesive layer is deformed by a predetermined amount, but does not undergo the excessive performance deformation.

For example, the modulus of the adhesive layer 130 may be 1.2×10⁵ Pa to 1.3×10⁵ Pa, and desirably, 1.3×10⁵ Pa. If the modulus of the adhesive layer 130 is in the above-described range, the adhesive layer 130 may be softened by a pressure or heat applied from the outside. For example, if the adhesive layer has a high modulus of 1.4×10⁵ Pa exceeding the above-described range, the adhesive layer is not softened even though a pressure or heat is applied from the outside. For example, if the modulus of the adhesive layer is below the above-described range, the adhesive layer is excessively softened by the pressure or heat applied from the outside so that it may be difficult to maintain a shape of the adhesive layer.

For example, the melting point of the adhesive layer 130 may be 130° C. to 140° C., and desirably, may be 140° C. For example, if the melting point of the adhesive layer 130 is within the above-described range, the adhesive layer 130 may be softened without causing the performance deformation due to the heat. For example, the adhesive layer 130 may be deformed by the heat in the environment exceeding 140° C. and may not be softened in the environment below 130° C.

In the display device 100 according to the exemplary embodiment of the present disclosure, the adhesive layer 130 has an adhesive strength of 10 N/20 mm to 11 N/20 mm, which is a similar level to a generally used adhesive layer.

Accordingly, in the display device 100 according to the exemplary embodiment of the present disclosure, the adhesive layer 130 is softened by heat, and has a good adhesive strength without undergoing performance deformation that it is completely melted by heat.

The cover window 140 may be disposed on the adhesive layer 130. The cover window 140 has a shape corresponding to the display panel 110 and is disposed so as to cover the display panel 110. The cover window 140 may protect the display panel 110 from impacts, moisture, heat, and scratches from the outside. The cover window 140 may be, for example, tempered glass, but is not limited thereto, and may also be a flexible plastic based cover which is foldable for the small thickness and flexibility of the display device 100.

Further, the cover window 140 may have a multi-layered structure in which various functional layers are laminated. For example, the cover window 110 may include various functional layers such as external light reflection reducing layer, a UV blocking layer, or a hard coating layer. Further, a touch panel which forms a touch sensor may be selectively disposed between the display panel 110 and the cover window 140 as needed.

In the display device 100 according to the exemplary embodiment of the present disclosure, in a non-emission mode of the light emitting diode as illustrated in FIG. 3A, the decoration film 120 of the display device 100 is visible to a user and in an emission-mode of the light emitting diode as illustrated in FIG. 3B, an input image input to the display device 100 is visible to the user. For example, in the emission mode of the light emitting diode, if necessary, the decoration film 120 is also visible together or only the input image is visible.

At this time, in order to make a texture of the design or pattern of the decoration film 120 more three-dimensionally visible, a surface of the cover window 140 adjacent to the adhesive layer 130 may include a plurality of uneven structures 141. At this time, the uneven structure 141 is also referred to as an embossing structure 141.

In the display device 100 according to the exemplary embodiment of the present disclosure, the plurality of uneven structures 141 may be formed without being limited to a position as long as it makes the texture of the design or pattern of the decoration film 120 three-dimensionally visible to a user. For example, referring to FIG. 2, the plurality of uneven structures 141 may be disposed in an area corresponding to the non-active area NA of the display panel 110. However, the present disclosure is not limited thereto and the plurality of uneven structures 141 may be disposed in an area corresponding to the active area AA of the display panel or may also be disposed in an area corresponding to the non-active area NA and the active area AA.

In the related art, the decoration film is attached onto the cover window using an optically clear adhesive (OCA). However, when the uneven structure is formed on the surface of the cover window to make the decoration film more three-dimensionally visible, a manufacturing time of the display device is increased because it is difficult to attach the cover window and the decoration film using the optically clear adhesive. Further, steps caused by the uneven structure of the surface of the cover window are not covered by the optically clear adhesive, which causes a problem that bubbles are generated between the cover window and the decoration film. Further, when bubbles are generated, a defect rate increases so that a good quality rate of the display device decreases. Accordingly, in the related art, it is difficult to apply the design or pattern of the decoration film including various shapes or textures to be three-dimensionally visible.

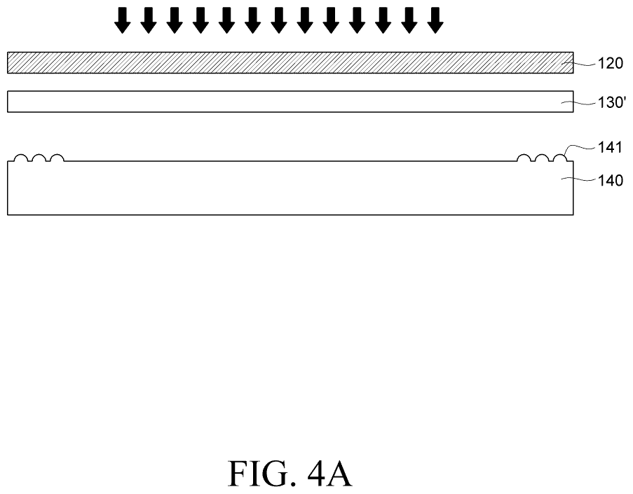

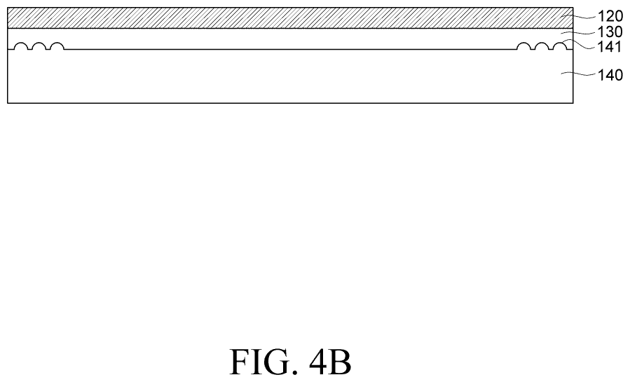

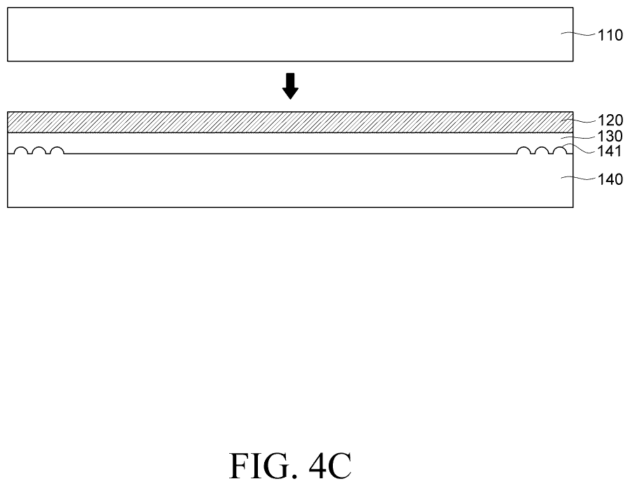

Accordingly, in the display device 100 according to the exemplary embodiment of the present disclosure, an adhesive layer 130 which is thermoplastic polyurethane having a lower modulus and a higher melting point, than those of the optically clear adhesive which has been used in the related art, is used to integrally form the decoration film 120 and the cover window 140. Therefore, the design or pattern of the decoration film 120 including various shapes or textures is three-dimensionally visible. The integration of the decoration film 120 and the cover window 140 using the adhesive layer 130 will be described in detail with reference to FIGS. 4A to 4C to be described below.

In the display device 100 according to the exemplary embodiment of the present disclosure, the adhesive layer 130 formed of a thermoplastic polyurethane is softened by heat, and has a good adhesive strength without undergoing performance deformation that it is completely melted by heat. Accordingly, a space between the plurality of uneven structures 141 of the cover window 140 is completely filled with the adhesive layer 130 without generating bubbles. In the meantime, a polarization layer is disposed between the display panel 110 and the decoration film 120. The polarization layer is a layer for planarizing incident light and absorbs external light and reflected light thereof with a film having a predetermined level of light transmittance to suppress degradation of a contrast ratio. Specifically, the display panel 110 includes various metal materials applied to the semiconductor element, the wiring line, and the organic light emitting diode. Therefore, the external light incident onto the display panel 110 may be reflected from the metal material so that the visibility of the display device 100 may be reduced due to the reflection of the external light. Therefore, the polarization layer is disposed to suppress the reflection of the external light, thereby suppressing the degradation of the display quality.

Further, when the display device 100 includes the polarization layer, for example, between the display panel 110 and the decoration film 120, an adhesive member is disposed between the polarization layer and the decoration film 120. The adhesive member may fix the display panel 110 and the decoration film 120. The adhesive member minimizes foreign materials or bubbles generated between the display panel 110 and the decoration film 120 and uses an adhesive which is optically transparent, such as an optically clear adhesive (OCA) or an optical clear resin (OCR), but is not limited thereto.

In the display device 100 according to the exemplary embodiment of the present disclosure, the cover window 140 and the decoration film 120 are integrated using the adhesive layer 130. Accordingly, the adhesive layer 130 is completely filled between the plurality of uneven structures 141 of the cover window 140 without generating bubbles so that the problem that the bubbles are generated between the cover window 140 and the decoration film 120 is suppressed. Further, the defect rate of the display device is significantly reduced. Hereinafter, the integration of the decoration film 120 and the cover window 140 using the adhesive layer 130 will be described in detail with reference to FIGS. 4A to 4C to be described below.

FIGS. 4A to 4C are schematic diagrams illustrating a manufacturing method of a display device according to an exemplary embodiment of the present disclosure. The manufacturing method of FIGS. 4A to 4C is a method for manufacturing a display device of FIGS. 1 to 3 and the same configuration may be denoted by the same reference numeral. Here, the description for the same reference numeral may refer to FIGS. 1 to 3.

First, referring to FIG. 4A, a cover window 140, an adhesive layer composition 130′ formed of thermoplastic polyurethane, and a decoration film 120 which are sequentially laminated are prepared and are subject to hot press. For example, the hot press is performed at a temperature of 150° C. to 160° C., for example, at 160° C. and at a bonding pressure of 0.7 kgf to 0.9 kgf.

Referring to FIGS. 4A and 4B, even though the plurality of uneven structures 141 is included on the surface of the cover window adjacent to the adhesive layer composition 130′, the adhesive layer composition 130′ having a low modulus is softened by heat to form an adhesive layer 130 which is completely filled between the plurality of uneven structures 141. Therefore, the decoration film 120 and the cover window 140 may be integrated without generating bubbles therebetween.

Specifically, in the display device 100 according to the exemplary embodiment of the present disclosure, the cover window 140 and the decoration film 120 may be less deformed by heat. For example, the cover window 140 may be a tempered glass. For example, the decoration film 120 may include a material having a high melting point to be less deformed by heat. For example, the melting point of the decoration film 120 may be higher than a temperature during hot press. Accordingly, for example, even though the hot press is performed at the temperature of 150° C. to 160° C., the cover window 140 and the decoration film 120 having a melting point higher than the temperature of hot press are not deformed by heat.

In the display device 100 according to the exemplary embodiment of the present disclosure, the melting point of the adhesive layer composition 130′ which bonds the cover window 140 and the decoration film 120 may be 130° C. to 140° C., and for example, 140° C. Therefore, for example, when the hot press is performed at a temperature of 150° C. to 160° C., the adhesive layer composition 130′ may be deformed by heat. Therefore, the adhesive layer composition 130′ having a low modulus is softened by heat applied during the hot press to be the adhesive layer 130 which is completely filled in the steps caused by the plurality of uneven structures 141 of the surface of the cover window 140. Accordingly, bubbles are not generated between the cover window 140 and the decoration film 120, specifically, between the cover window 140 and the adhesive layer 140 so that the defect rate of the display device is reduced.

For example, if the melting point of the adhesive layer exceeds 140° C., even though hot press is performed, the adhesive layer is not deformed so that the steps caused by the plurality of uneven structures of the surface of the cover window are not filled. For example, if the melting point of the adhesive layer is lower than 130° C., the adhesive layer is completely melted during the hot press so that the adhesive layer cannot be filled in the steps caused by the plurality of uneven structures of the surface of the cover window.

Referring to FIG. 4C, the display panel 110 is attached onto the cover window 140, the adhesive layer 130, and the decoration film 120 which are integrated. Specifically, the display panel 110 is attached onto one surface of the decoration film 120. For example, the display panel 110 and the decoration film 120 may be fixed using an adhesive which is optically transparent, such as an optically clear adhesive (OCA) or an optical clear resin (OCR).

In the display device 100 according to the exemplary embodiment of the present disclosure, the cover window 140, the adhesive layer 130, and the decoration film 120 are integrated by the hot press to integrate the cover window 140, the adhesive layer 130, and the decoration film 120 without generating bubbles.

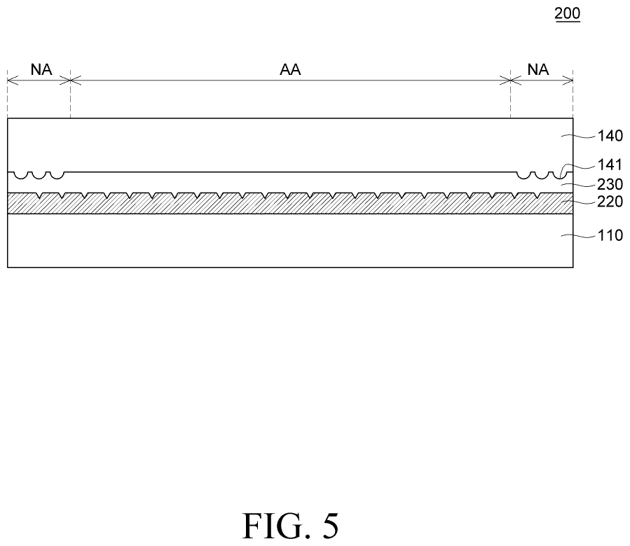

FIG. 5 is a cross-sectional view of a display device according to another exemplary embodiment of the present disclosure. A display device 200 of FIG. 5 is substantially the same as the display device 100 of FIGS. 1 to 4 except for an adhesive layer 230 and a decoration film 220 so that a redundant description will be omitted.

In the display 200 according to another exemplary embodiment of the present disclosure, in the non-emission mode of the light emitting diode, the decoration film 220 of the display device 200 is visible to a user and in the emission mode of the light emitting diode of the display device 200, an input image input to the display device 200 is visible to the user. For example, in the emission mode of the light emitting diode, if necessary, the decoration film 220 is also visible together or only the input image is visible.

At this time, in order to make the texture of the design or pattern of the decoration film 220 more three-dimensionally visible, a surface of the decoration film 220 adjacent to the adhesive layer 230 may include a plurality of grooves 221. However, as long as the grooves show the texture of the design or pattern of the decoration film 220, the grooves may be included on the surface of the decoration film 220 without limitation. For example, the surface of the decoration film 220 may include a plurality of protrusions.

In the display device 200 according to another exemplary embodiment of the present disclosure, the plurality of grooves 221 may be formed without being limited to a position as long as it makes the texture of the design or pattern of the decoration film 220 three-dimensionally visible to a user. For example, the plurality of grooves 221 may be disposed in an area corresponding to the non-active area NA of the display panel 110. However, the present disclosure is not limited thereto and the plurality of grooves 221 may be disposed in an area corresponding to the active area AA of the display panel or may also be disposed in an area corresponding to the non-active area NA and the active area AA.

In the related art, the decoration film is attached onto the cover window using an optically clear adhesive (OCA). However, when the plurality of grooves is formed on the surface of the decoration film to make the decoration film more three-dimensionally visible, a manufacturing time of the display device is increased because it is difficult to attach the cover window and the decoration film using the optically clear adhesive. Further, steps caused by the plurality of grooves of the surface of the decoration film are not covered by the optically clear adhesive, which causes a problem in that bubbles are generated between the cover window and the decoration film. Further, a defect rate increases when bubbles are generated so that a good quality rate of the display device decreases. Accordingly, in the related art, it is difficult to apply the design or pattern of the decoration film including various shapes or textures to be three-dimensionally visible.

Accordingly, in the display device 200 according to another exemplary embodiment of the present disclosure, the decoration film 220 and the cover window 140 are integrated using an adhesive layer 230 formed of a thermoplastic polyurethane. The adhesive layer 230 is softened by heat, but has a good adhesive strength without undergoing performance deformation that it is completely melted by heat. Accordingly, even though the plurality of grooves 221 is included on the surface of the decoration film 220 to make the design or pattern three-dimensionally visible, including various shapes or textures, the spaces in the plurality of grooves of the decoration film 220 may be completely filled with the adhesive layer 230 without generating bubbles.

In the display device 200 according to another exemplary embodiment of the present disclosure, the plurality of grooves 221 may be included on the surface of the decoration film 220. Accordingly, the texture of the design or pattern of the decoration film 220 may be more three-dimensionally visible.

In the display device 200 according to another exemplary embodiment of the present disclosure, the cover window 140 and the decoration film 220 are integrated using the adhesive layer 230. Accordingly, the adhesive layer 230 is completely filled in the spaces in the plurality of grooves 221 of the decoration film 220 without generating bubbles so that the problem that the bubbles are generated between the cover window 140 and the decoration film 220 is suppressed. Further, the defect rate of the display device is significantly reduced.

The exemplary embodiments of the present disclosure can also be described as follows:

According to an aspect of the present disclosure, a display panel, a decoration film disposed on the display panel, an adhesive layer which is disposed on the decoration film and is formed of thermoplastic polyurethane, and a cover window on the adhesive layer.

A surface of the cover window adjacent to the adhesive layer includes a plurality of uneven structures and the adhesive layer may be completely filled between the plurality of uneven structures.

A storage modulus of the adhesive layer may be 1.2×10⁵ Pa to 1.3×10⁵ Pa.

A melting point of the adhesive layer may be 130° C. to 140° C.

A surface of the decoration film adjacent to the adhesive layer includes a plurality of grooves and the plurality of grooves may be completely filled with the adhesive layer.

A melting point of the decoration film may be 180° to 200° C.

According to an another aspect of the present disclosure, a display panel including an active area in which a plurality of sub pixels is disposed and a non-active area which encloses the active area, a plurality of light emitting diodes which is disposed in each of the plurality of sub pixels, a decoration film disposed on the display panel, an adhesive layer which is disposed on the decoration film and is formed of thermoplastic polyurethane and a cover window on the adhesive layer, in an emission mode of the plurality of light emitting diodes, an image input to the display panel is exposed and in a non-emission mode of the plurality of light emitting diodes, the decoration film is exposed.

A surface of the cover window adjacent to the adhesive layer may include a plurality of uneven structures and the adhesive layer may be completely filled between the plurality of uneven structures.

A surface of the decoration film adjacent to the adhesive layer may include a plurality of grooves and the plurality of grooves may be completely filled with the adhesive layer.

The plurality of uneven structures or the plurality of grooves may be disposed so as to correspond to the non-active area of the display panel.

The plurality of uneven structures or the plurality of grooves may be disposed so as to correspond to the active area of the display panel.

It will be apparent to those skilled in the art that various modifications and variations can be made in the display device of the present disclosure without departing from the technical idea or scope of the disclosure. Thus, it is intended that the present disclosure cover the modifications and variations of this disclosure provided they come within the scope of the appended claims and their equivalents.

What is claimed is:

1. A display device, comprising:
a display panel;
a decoration film disposed on the display panel;
an adhesive layer which is disposed on the decoration film and is formed of thermoplastic polyurethane; and
a cover window on the adhesive layer.

2. The display device according to claim 1, wherein a surface of the cover window adjacent to the adhesive layer includes a plurality of uneven structures and the adhesive layer is completely filled between the plurality of uneven structures.

3. The display device according to claim 2, wherein a storage modulus of the adhesive layer is 1.2×10⁵ Pa to 1.3×10⁵ Pa.

4. The display device according to claim 2, wherein a melting point of the adhesive layer is 130° C. to 140° C.

5. The display device according to claim 1, wherein a surface of the decoration film adjacent to the adhesive layer includes a plurality of grooves and the plurality of grooves is completely filled with the adhesive layer.

6. The display device according to claim 5, wherein a melting point of the decoration film is 180° to 200° C.

7. A display device, comprising:
a display panel including an active area in which a plurality of sub pixels is disposed and a non-active area which encloses the active area;
a plurality of light emitting diodes which is disposed in each of the plurality of sub pixels;
a decoration film disposed on the display panel;
an adhesive layer which is disposed on the decoration film and is formed of thermoplastic polyurethane; and
a cover window on the adhesive layer,
wherein in an emission mode of the plurality of light emitting diodes, an image input to the display panel is exposed and in a non-emission mode of the plurality of light emitting diodes, the decoration film is exposed.

8. The display device according to claim 7, wherein a surface of the cover window adjacent to the adhesive layer includes a plurality of uneven structures and the adhesive layer is completely filled between the plurality of uneven structures.

9. The display device according to claim 7, wherein a surface of the decoration film adjacent to the adhesive layer includes a plurality of grooves and the plurality of grooves is completely filled with the adhesive layer.

10. The display device according to claim 8, wherein the plurality of uneven structures or the plurality of grooves is disposed so as to correspond to the non-active area of the display panel.

11. The display device according to claim 8, wherein the plurality of uneven structures or the plurality of grooves is disposed so as to correspond to the active area of the display panel.
